(19) United States
(12) Patent Application Publication
(10) Pub. No.: US 2004/0257417 A1
(43) Pub. Date: Dec. 23, 2004

(54) Inkjet printing method

(76) Inventors: Christian Jackson, Wilmington, DE (US); Harry Joseph Spinelli, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/825,252

(22) Filed: Apr. 15, 2004

Related U.S. Application Data
(60) Provisional application No. 60/465,955, filed on Apr. 28, 2003.

(51) Int. Cl. C09D 11/00

(52) U.S. Cl. 347/100

(57) ABSTRACT

This invention pertains to a method of inkjet printing, in particular to a method of inkjet printing designed for high speed, high quality and high resolution. The method employs a printhead array which is fixed in position and which ejects ink droplets of about 1-2 pL, and dye-based inks having specified dye contents.

### CROSS-REFERENCE TO RELATED APPLICATIONS

This application claims priority under 35 U.S.C. §119 from U.S. Provisional Application Ser. No. 60/465,955 (filed Apr. 28, 2003), the disclosure of which is incorporated by reference herein for all purposes as if fully set forth.

### BACKGROUND OF THE INVENTION

This invention pertains to a method of inkjet printing, in particular to a method of inkjet printing designed for high speed, high quality and high resolution.

Inkjet printing is a non-impact printing process in which droplets of ink are deposited on print media, such as paper, to form the desired image. The droplets are ejected from a printhead in response to electrical signals generated by a microprocessor.

Inkjet printers offer low cost, high quality printing and have become a popular alternative to other types of printers. However, inkjet printers are presently unable to match the speed of laser printers, partly due to small printheads which must scan across the substrate, and partly due to the relatively slow dry time of inkjet inks and associated slow-down from the bleed control algorithms in the printer software.

The use of page-wide printhead arrays is one potential solution for faster print speeds. Speed is achieved by applying ink from a large number of nozzles in one pass of the substrate. There is, however, still the problem of bleed control and ink dry-time. Recently, arrays have been proposed which minimize bleed and dry-time by jetting small (1-2 pL) drops. See, for example, U.S. Pat. No. 6,443,555, which is incorporated by reference herein for all purposes as if fully set forth. The small drops also allow “photo quality” images. However, to take advantage of this system, or any other system of this sort, suitable inks are needed.

Use of color inks with soluble dye colorant is desirable because of the high chroma possible. The dyes, being soluble in the ink vehicle, are also generally easily jetted with high reliability. However, it was discovered and will be shown hereinafter that use of current commercial dye inks will not be suitable for 1-2 pL drops from an array because the optical density and chroma will be poor relative to current printers. Speed cannot be achieved at the expense of print quality.

The printhead in current printers generally scans the width of the printed page. If optical density of the printed image is inadequate on a particular substrate, which happens more frequently with small drop sizes, one solution is to engage a multi-pass print mode. This is done at great expense to speed. Another solution is exemplified by Canon i950 printer where the printhead is able to apply the same ink at two different drop volumes, a ca. 2 pL drop for printing on special media and a 5 pL drop for printing larger volumes in a single pass when higher density is needed.

In the case of fixed array printheads, multiple substrate passes are not practical and the use of larger drops will increase bleed problems. A need exists, therefore, for inkjet ink formulations that provide good image quality and good jetting performance in fixed array printheads firing small drops.

### SUMMARY OF THE INVENTION

In accordance with one aspect of the present invention, there is provided a method of inkjet printing a substrate, comprising the steps of:

(a) providing an ink jet printer that is responsive to digital data signals, said printer being equipped with a printhead array which is fixed in position (“fixed array”) and which ejects ink droplets of about 1-2 pL;

(b) loading the printer with the substrate to be printed;

(c) loading the printer with a color ink jet ink set comprising:

(i) a cyan ink having a vehicle and at least about 2.5 percent by weight of soluble cyan dye,

(ii) a magenta ink having a vehicle and at least about 3.6 percent by weight of soluble magenta dye and

(iii) a yellow ink having a vehicle and at least about 3.0 percent by weight of soluble yellow dye; and

(d) moving the substrate past the printhead array and printing on the substrate using the inkjet ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

### DETAILED DESCRIPTION OF THE PREFERRED EMBODIMENTS

Ink jet printers suitable for use in the present invention are responsive to digital data signals, and are equipped with a printhead array which is fixed in position (fixed array) and which ejects ink droplets of about 1-2 pL. The printer can be, for example, similar to that described in previously incorporated U.S. Pat. No. 6,443,555. The printhead(s) for such a printer can be, for example, those described in U.S. Pat. No. 6,426014 and U.S.20020033863, the disclosures of which are also incorporated by reference herein for all purposes as if fully set forth.

The fixed array printers preferably are capable of printing at least about 1200 dpi, and more preferably at least about 1600 dpi. Still more preferably, this dpi can be achieved in a single pass of the substrate.

The width of the printing zone is at least as wide as the width of the area to be printed so that printing can be performed rapidly in one pass. For example, for so-called “SOHO” (small office home office) and “network” printing, the width of the printing zone is at least wide as standard papers, such as A4 paper and/or 8.5×11 inch paper. For so-called “wide-format” printing, the print zone is preferably at least about 36 inches wide and can accommodate media that is fed from a roll.

Substrates suitable for use in the present invention can be any useful substrate known to those of ordinary skill in the relevant art. For example, the substrate can be plain paper such as common electrophotographic copier paper. The substrate can also be specialty media such as microporous papers, polymer coated papers and hybids of the two. The substrate can be polymeric film such as vinyl chloride and polyester. Polymeric films are especially useful in wide-format applications such as signs, billboards and banners. The substrate can be a non-woven textile such as spun bonded polyolefin (e.g. Tyvek®, DuPont Co.). The substrate can also be woven textile such as silk, cotton, nylon and polyester.

Ink sets suitable for use with the present invention comprise at least three primary color inks: a cyan ink, a magenta ink and a yellow ink. Each of these primary color inks is in turn comprised of a vehicle and an appropriate colorant, which is a dye and which is soluble the vehicle. The ink set may optionally contain additional inks and/or one or more separate fixing fluids and/or overcoats.

Conventional dyes such as anionic, cationic, amphoteric and non-ionic dyes are useful in this invention. Such dyes are well known to those of ordinary skill in the art. Anionic dyes are those dyes that, in aqueous solution, yield colored anions. Cationic dyes are those dyes that, in aqueous solution, yield colored cations. Typically anionic dyes contain carboxylic or sulfonic acid groups as the ionic moiety. Cationic dyes usually contain quaternary nitrogen groups.

The types of anionic dyes most useful in this invention are, for example, Acid, Direct, Food, Mordant and Reactive dyes. Anionic dyes are selected from the group consisting of nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

The types of cationic dyes that are most useful in this invention include mainly the basic dyes and some of the mordant dyes that are designed to bind acidic sites on a substrate, such as fibers. Useful types of such dyes include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds, and thiazine compounds, among others, all of which are well known to those skilled in the art.

Useful dyes include (cyan) Acid Blue 9 and Direct Blue 199; (magenta) Acid Red 52, Reactive Red 180, Acid Red 37, Cl Reactive Red 23; and (yellow) Direct Yellow 86, Direct Yellow 132 and Acid Yellow 23.

The ink set may optionally include a black ink, and the colorant therefor may be a soluble dye and/or pigment. Pigment is generally preferred for black from the standpoint of high optical density. A preferred black pigment is a carbon black pigment.

Traditionally, pigments are stabilized to dispersion in a vehicle by dispersing agents, such as polymeric dispersants or surfactants. More recently though, so-called “self-dispersible” or “self-dispersing” pigments (hereafter “SDP”) have been developed. As the name would imply, SDPs are dispersible in water, or aqueous vehicle, without dispersants. The black pigment may be stabilized to dispersion by surface treatment to be self-dispersing (see, for example, WO01/94476, which is incorporated by reference herein for all purposes as if fully set forth), by treatment with dispersant in the traditional way, or by some combination of surface treatment and dispersant.

Preferably, when dispersant is employed, the dispersant(s) is a random or structured polymeric dispersant. Preferred random polymers include acrylic polymer and styrene-acrylic polymers. Most preferred are structured dispersants which include AB, BAB and ABC block copolymers, branched polymers and graft polymers. Some useful structured polymers are disclosed in U.S.5085698, EP-A-0556649 and U.S. Pat No. 5,231,131, the disclosures of which are incorporated by reference herein for all purposes as if fully set forth.

Useful pigment particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

The black colorant may also be dye as, for example, the black dye disclosed in U.S. Pat No. 5,753,016. The black colorant may also be a combination of dye and pigment as, for example, disclosed in U.S. Pat No. 6,277,184. The disclosures of both preceding references are incorporated by reference herein for all purposes as if fully set forth.

The vehicle can be aqueous or nonaqueous. The term “aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in previously incorporated U.S. Pat No. 5,085,698.

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

Inks based on aqueous vehicles can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n- propyl ether, and dipropylene glycol mono-isopropyl ether. 1,2-Alkanediols are preferably 1,2-C4-6 alkanediols, most preferably 1,2- hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1 ,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink. “Nonaqueous vehicle” refers a vehicle that is substantially comprised of a nonaqueous solvent or mixtures of such solvents, which solvents can be polar and/or nonpolar. Examples of polar solvents include alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene and triethylene glycols. Examples of nonpolar solvents include aliphatic and aromatic hydrocarbons having at least six carton atoms and mixtures thereof including refinery distillation products and by-products.

Even when no water is deliberately added to the nonaqueous vehicle, some adventitious water may be carried into the formulation, but generally this will be no more than about 24%. By definition, the nonaqueous ink of this invention will have no more than about 10%, and preferably no more than about 5%, by weight of water based on the total weight of the nonaqueous vehicle.

Other ingredients may be formulated into the inkjet ink, to the extent that such other ingredients do not interfere with the stability and jetablity of the ink, which may be readily determined by routine experimentation. Such other ingredients are in a general sense well known in the art.

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes.

Biocides may be used to inhibit growth of microorganisms.

Inclusion of sequestering (or chelating) agents such as ethylenediamine-tetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″, N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the application contemplated by this invention will generally require lower viscosity ink. Thus the viscosity (at 25° C.) of the inventive inks (and fixer if used) can be less than about 7 cps, is preferably less than about 5 cps, and most advantageously is less than about 3.5 cps.

The ink set is designed, when ejected in droplet sizes of 1-2 pL, to achieve optical density (OD) values of printed images comparable to current commercial printers, which typically eject droplet sizes of about 5 pL or greater. To establish those target values, prints were made with a S750 (Canon) and a HP 970 (Hewlett Packard) printer on Xerox 4024 paper using the inks supplied by the manufacturer. Both “standard” and “best” modes were evaluated.

The Optical density results are given below. Measurement was made with a Greytag-Macbeth SpectroEye (Greytag-Macbeth AG, Regensdorf, Switzerland).

| | | Optical Density | | | |
|---|---|---|---|---|---|
| Printer | Mode | Black | Cyan | Magenta | Yellow |
| HP 970 | Standard | 1.40 | 1.05 | 1.10 | 0.95 |
| | Best | 1.30 | 1.05 | 1.20 | 1.15 |
| Canon S750 | Standard | 1.40 | 1.10 | 1.00 | 0.85 |
| | Best | 1.33 | 1.25 | 1.20 | 1.15 |

Both of these printers use multiple passes in the best mode to achieve high OD. With a fixed array printhead, such as the printhead specified by this invention, there will generally be only one pass possible and most preferably best mode OD will be achieved in one pass. Thus, the instant printing method is preferably able to achieve optical density values as follows:

| | | More |
|---|---|---|
| Color | Preferred OD | preferred OD |
| Cyan | 1.10 | 1.25 |
| Magenta | 1.10 | 1.20 |
| Yellow | 0.95 | 1.15 |

To determine colorant levels needed to meet the desired optical density targets, the relationship of dye concentration, drop size and optical density was modeled. As will be shown herein after, dye concentrations suitable for larger drops are not adequate for 1-2 pL drops.

The measured data consist of optical density measurements made for inks covering a range of colorant concentrations from about 1 % to 4.5% printed from three different print heads firing 30 pL, 20 pL and 5 pL drops respectively. The 30 pL drops were printed with the black printhead in an HP 990 (Hewlett Packard) printer, the 20 pL drops were printed with the S750 black printhead, and the 5 pL drops were printed with the S750 magenta printhead. The paper was Xerox 4024; coverage was 100%.

To prepare the inks, the particular dye, at the desired weight percent, was dissolved in the vehicle according to the following recipe.

| Ingredient | Weight Percent |
|---|---|
| Dye | Various |
| 1,2 Hexanediol | 4.0 |
| Glycerol | 10.0 |
| Ethylene glycol | 1.0 |
| 2-pyrrolidone | 3.0 |
| Triethanolamine | 0.2 |
| Proxel | 0.2 |
| Water | Balance |

The dye for the cyan ink was C.I. (Color Index) number AB9. Cyan inks were formulated at various weight percent dye. Thus cyan ink with 1 weight percent dye contains 1% AB9 and 99% vehicle. The vehicle is adjusted with water as needed to account for the different colorant concentration in the various inks. In the same way, the magenta inks were made with C.I. AR52 dye and yellow inks were made with C.I. AY23 dye.

| | | | |
|---|---|---|---|
| Wt % dye | 30 pl drops | 20 pL drops | 5 pl drops |

Optical Densities Values for Cyan Ink (100% Fill)

| | | | |
|---|---|---|---|
| 1 | 1.17 | 1.11 | 0.96 |
| 1.5 | 1.30 | 1.20 | 1.06 |
| 2 | 1.41 | 1.28 | 1.17 |
| 2.5 | 1.42 | 1.34 | 1.22 |
| 3 | 1.46 | 1.38 | 1.27 |
| 4.5 | 1.53 | 1.46 | 1.36 |

Optical Densities Values for Magenta Ink (100% Fill)

| | | | |
|---|---|---|---|
| 1 | 0.90 | 0.94 | 0.87 |
| 1.5 | 1.00 | 1.04 | 0.97 |
| 2 | 1.09 | 1.14 | 1.05 |
| 2.5 | 1.19 | 1.15 | 1.09 |
| 3 | 1.23 | 1.26 | 1.20 |
| 4.5 | 1.33 | 1.35 | 1.29 |

Optical Densities Values for Yellow Ink (100% Fill)

| | | | |
|---|---|---|---|
| 1 | 0.98 | 0.87 | 0.71 |
| 1.5 | 1.10 | 1.01 | 0.85 |
| 2 | 1.17 | 1.10 | 0.96 |
| 2.5 | 1.24 | 1.16 | 1.02 |
| 3 | 1.29 | 1.20 | 1.06 |
| 4.5 | 1.35 | 1.28 | 1.17 |

The model considers optical density to be a sum of a linear function of the logarithm of the colorant concentration and a linear function of the logarithm of the drop size. A multiple variable linear regression was used to fit the experimental optical density data to a regression equation of the form:

Optical Density=[(a)log(drop volume)+[(b)log(dye concentration)]+c

Where a, b and c are constants for the given colorant and media determined by the regression. The equations based on these two variables was found to predict over 95% of the variation in the experimental data providing an accurate model of the optical density data. The regression and statistical analysis were performed using the Minitab software package (Minitab Inc.). The regression equation was then used to extrapolate optical densities for inks using different levels of dye concentration and printed with smaller size drops.

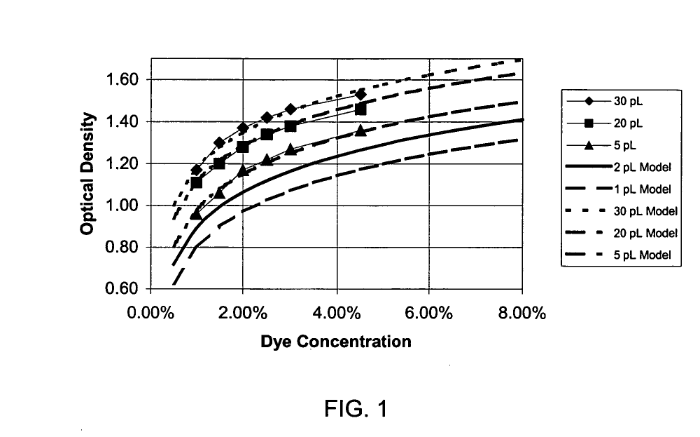

The data, fitted curves and extrapolated values are shown graphically for cyan in FIG. 1. The magenta and yellow inks were treated in the same way.

The weight percent of dye needed to achieve the target optical density for each color is as follows.

| | | | |
|---|---|---|---|
| Target OD | 2 pL drop | 1.5 pL drop | 1 pL drop |

% Weight Cyan Dye needed for Target Optical Density

| | | | |
|---|---|---|---|
| 1.10 | 2.5 | 2.75 | 3.5 |
| 1.25 | 4.25% | 4.9% | 6.1% |

% Weight Magenta Dye needed for Target Optical Density

| | | | |
|---|---|---|---|
| 1.10 | 3.6 | 4.1 | 5.0 |
| 1.20 | 5.1% | 5.8% | 6.9% |

% Weight Yellow Dye needed for Target Optical Density

| | | | |
|---|---|---|---|
| 0.95 | 3.0% | 3.5% | 4.3% |
| 1.15 | 6.1% | 7.2% | 8.9% |

Although adding more colorant will continue to increase OD, chroma will peak and then start to decrease. It is desirable to maintain high chroma as well as high OD, therefore dye levels should not greatly exceed prescribed values. In general. Such as for the about 1 pL drops, the upper limit for cyan dye is about 8 weight percent, the upper limit for magenta dye is about 10 weight percent and the upper for yellow dye is about 11.5%. For somewhat larger drops, for example the about 1.5 pL and 2 pL drops, the upper weight percent limits may be somewhat lower.

A preferred embodiment of the instant invention includes a printhead which prints about 2 pL drops and an ink set comprising a cyan ink having a vehicle and at least 2.5 percent by weight of soluble cyan dye, a magenta ink having a vehicle and at least 3.6 percent by weight of soluble magenta dye a yellow ink having a vehicle and at least 3.0 percent by weight of soluble yellow dye.

In another preferred embodiment the instant invention includes a printhead which prints about 2 pL drops and an ink set comprising a cyan ink having a vehicle and at least 4.25 percent by weight of soluble cyan dye, a magenta ink having a vehicle and at least 5.1 percent by weight of soluble magenta dye a yellow ink having a vehicle and at least 6.1 percent by weight of soluble yellow dye.

In another preferred embodiment the instant invention includes a printhead which prints about 1.5 pL drops and an ink set comprising a cyan ink having a vehicle and at least 2.75 percent by weight of soluble cyan dye, a magenta ink having a vehicle and at least 4.1 percent by weight of soluble magenta dye a yellow ink having a vehicle and at least 3.5 percent by weight of soluble yellow dye.

In another preferred embodiment the instant invention includes a printhead which prints about 1.5 pL drops and an ink set comprising a cyan ink having a vehicle and at least 4.9 percent by weight of soluble cyan dye, a magenta ink having a vehicle and at least 5.8 percent by weight of soluble magenta dye a yellow ink having a vehicle and at least 7.2 percent by weight of soluble yellow dye.

In another preferred embodiment the instant invention includes a printhead which prints about 1 pL drops and an ink set comprising a cyan ink having a vehicle and at least 3.5 percent by weight of soluble cyan dye, a magenta ink having a vehicle and at least 5.0 percent by weight of soluble magenta dye a yellow ink having a vehicle and at least 4.3 percent by weight of soluble yellow dye.

In another preferred embodiment the instant invention includes a printhead which prints about 1 pL drops and an ink set comprising a cyan ink having a vehicle and at least 6.1 percent by weight of soluble cyan dye, a magenta ink having a vehicle and at least 6.9 percent by weight of soluble magenta dye a yellow ink having a vehicle and at least 8.9 percent by weight of soluble yellow dye.

In any of these embodiments, the cyan dye is preferably C.I. AB9 dye, the magenta dye is preferably C.I. AR52 dye and the yellow dye is preferably C.I. AY23 dye.

The ink set employed in the instant invention can further include a black ink. The colorant in the black ink can be dye or pigment, however achievement of sufficient OD with black dye will be difficult and therefor a black pigment is preferred, most preferably carbon black pigment. The drop size of the optional black ink can be the same as the drop size of the color dye inks being jetted, 1-2 pL, or it can be a different (larger) size. A larger drop size for the black ink may be advantageous for achieving higher OD.

In accord with the final aspect of the present invention, the substrate to be printed is moved past the printhead in such manner as to allow the desired image to be printed. Printing is preferably accomplished in one pass. An advantage of the present printing method and printer system therefor is the potential for fast print speeds. Thus, the substrate is preferably fed at a rate of at least about six linear inches per second, more preferably at least about 12 linear inches per second. In this arrangement, one page of A4 paper could be printed in 1-2 seconds.

1. A method of inkjet printing a substrate, comprising the steps of:
(a) providing an ink jet printer that is responsive to digital data signals, said printer being equipped with a printhead array which is fixed in position (“fixed array”) and which ejects ink droplets of about 1-2 pL;
(b) loading the printer with the substrate to be printed;
(c) loading the printer with a color ink jet ink set comprising:
(i) a cyan ink having a vehicle and at least about 2.5 percent by weight of soluble cyan dye,
(ii) a magenta ink having a vehicle and at least about 3.6 percent by weight of soluble magenta dye and
(iii) a yellow ink having a vehicle and at least about 3.0 percent by weight of soluble yellow dye; and
(d) moving the substrate past the printhead array and printing on the substrate using the inkjet ink set in response to the digital data signals.

2. The method of claim 1, wherein the inks of the ink set have viscosity (at 25° C.) of less than about 7 cps.

3. The method of claim 1, wherein the ink set further comprises a black ink.

4. The method of claim 1, wherein the cyan dye is C.I. AB9 dye, the magenta dye is C.I. AR52 dye and the yellow dye is C.I. AY23 dye.

5. The method of claim 1, wherein the inks of the ink set have an aqueous vehicle.

6. The method of claim 5, wherein the ink set further comprises a black ink.

7. The method of claim 1, wherein (i) the cyan ink has at least about 2.5 percent and up to about 8 percent by weight of soluble cyan dye, (ii) the magenta ink has at least about 3.6 percent up to about 10 percent by weight of soluble magenta dye, and (iii) the yellow ink has at least about 3.0 percent up to about 11.5 percent by weight of soluble yellow dye.

8. The method of claim 7, wherein the droplets are about 2 pL.

9. The method of claim 8, wherein (i) the cyan ink has at least about 4.25 percent by weight of soluble cyan dye, (ii) the magenta ink has at least about 5.1 percent by weight of soluble magenta dye, and (iii) the yellow ink has at least about 6.1 percent by weight of soluble yellow dye.

10. The method of claim 7, wherein the droplets are about 1.5 pL.

11. The method of claim 10, wherein (i) the cyan ink has at least about 2.75 percent by weight of soluble cyan dye, (ii) the magenta ink has at least about 4.1 percent by weight of soluble magenta dye, and (iii) the yellow ink has at least about 3.5 percent by weight of soluble yellow dye.

12. The method of claim 10, wherein (i) the cyan ink has at least about 4.9 percent by weight of soluble cyan dye, (ii) the magenta ink has at least about 5.8 percent by weight of soluble magenta dye, and (iii) the yellow ink has at least about 7.2 percent by weight of soluble yellow dye.

13. The method of claim 7, wherein the droplets are about 1 pL.

14. The method of claim 13, wherein (i) the cyan ink has at least about 3.5 percent by weight of soluble cyan dye, (ii) the magenta ink has at least about 5.0 percent by weight of soluble magenta dye, and (iii) the yellow ink has at least about 4.3 percent by weight of soluble yellow dye.

15. The method of claim 13, wherein (i) the cyan ink has at least about 6.1 percent by weight of soluble cyan dye, (ii) the magenta ink has at least about 6.9 percent by weight of soluble magenta dye, and (iii) the yellow ink has at least about 8.9 percent by weight of soluble yellow dye.

16. The method of claim 7, wherein the inks of the ink set have viscosity (at 25° C.) of less than about 7 cps.

17. The method of claim 7, wherein the ink set further comprises a black ink.

18. The method of claim 7, wherein the cyan dye is C.I. AB9 dye, the magenta dye is C.I. AR52 dye and the yellow dye is C.I. AY23 dye.

19. The method of claim 7, wherein the inks of the ink set have an aqueous vehicle.

20. The method of claim 19, wherein the ink set further comprises a black ink.
